(19) United States
(12) Patent Application Publication
(10) Pub. No.: US 2006/0166134 A1
(43) Pub. Date: Jul. 27, 2006

(54) Photoresist composition and method of forming a pattern using the same

(75) Inventors: Kyoung-Mi Kim, Anyang-si (KR); Youn-Kyung Wang, Yongin-si (KR); Young-Ho Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/332,636

(22) Filed: Jan. 13, 2006

(30) Foreign Application Priority Data
Jan. 25, 2005 (JP) 2005-0006517

(51) Int. Cl. G03C 1/76

(52) U.S. Cl. 430/270.1

(57) ABSTRACT

A photoresist composition is provided. The photosensitive composition includes a photosensitive resin present in an amount of about 4% by weight to about 10% by weight, a photo-acid generator (PAG) present in an amount of about 0.1% by weight to about 0.5% by weight and a residual amount of a solvent. The photosensitive resin comprises a first resin which includes a first blocking group and a second resin which includes a second blocking group having an activation energy less than the first blocking group.

### CROSS-REFERENCES TO RELATED APPLICATIONS

This application claims priority from Korean Patent Application No. 2005-6517 filed on Jan. 25, 2005, the content of which is incorporated by reference herein in its entirety.

### BACKGROUND OF THE INVENTION

1. Field of the Invention

The present invention relates to a photoresist composition and a method of forming a pattern using the same. More particularly, the present invention relates to a photoresist composition of which a photosensitive resin comprises a mixture of blocking groups and a method of forming the photoresist pattern using the photoresist composition.

2. Description of the Related Art

As semiconductor devices have become more highly integrated and are now operating at higher speeds, ultra-fine patterns having a line width of no more than about 100 nm are now needed. Conventionally, a photolithography process using a photosensitive material, such as a photoresist, is typically utilized in forming a pattern for a semiconductor device. The photolithography process generally includes a photoresist coating process, an aligning process, an exposing process and a developing process.

Namely, in forming the photoresist pattern for a semiconductor device, a photoresist, is coated on a substrate such as a silicon wafer by a photoresist coating process, thereby forming a photoresist film on the substrate. Next during an aligning process, a photo mask having an electronic circuit pattern, is placed over the wafer on which the photoresist film is to be formed. The photo mask is then illuminated with a light having a wavelength, to which the photoresist film is particularly sensitive. As a result of the above irradiation, photochemical reactions take place on the photoresist film which alter the molecular structure of the photoresist film, thereby causing, the electronic circuit pattern on the photo mask to be transcribed onto the photoresist film. Further, the developing process then selectively removes the photoresist film, thereby forming a photoresist pattern on the substrate.

A critical dimension of the photoresist pattern is determined in accordance with the resolution of an exposing system. The resolution of the exposing system is in turn determined by the wavelength of the illumination light according to Rayleigh's equation as follows:
R=K₁λ/NA [Equation 1]

In this Rayleigh's equation, λ denotes the wavelength of the illumination light of an exposing system, R denotes the resolution limit of an exposing system, K₁ denotes the proportional constant of the exposing process, and NA denotes the numerical aperture of a lens of the exposing process.

According to Rayleigh's equation, the wavelength λ of the illumination light and the proportional constant K₁ should be as small as possible, and the numerical aperture of a lens should be as large as possible to decrease the resolution limit of the exposing system. Thus, the higher the resolution of the exposing system is, the shorter the wavelength of the illumination light. Thus, to form a fine photoresist pattern, the wavelength of the illumination light should be reduced. Accordingly, the wavelength λ of the illumination light, the exposure apparatus for irradiating the illumination light having the wavelength λ and the critical dimension of the photoresist pattern are significant factors utilized for forming an ultra-fine pattern in which the line width is expressed in units of nanometers.

Photoresists are generally classified as either a negative type or a positive type photoresist. For example, when a positive photoresist is exposed to light, an acid is liberated from a photo-acid generator (PAG) in an exposed portion of the positive photoresist. The acid liberated from the PAG dissociates a particular blocking group from a photosensitive resin of the photoresist, in what is known as a de-blocking process. The minimal energy required for the dissociation of the blocking group from the photosensitive resin is referred to as the activation energy of the de-blocking process.

A quantity of energy greater than the activation energy, for initiating the de-blocking process, should be provided to dissociate the blocking group from the photosensitive resin. Therefore, the blocking group may be dissociated from the photosensitive resin at a low temperature when the blocking group comprises a material in which the activation energy is relatively low. Conventionally, a greater activation energy has been provided either by causing a stronger photo-acid to be liberated or by performing a post-etch bake (PEB) process at a higher temperature. Moreover, since photo energy is inversely proportional to the wavelength of light, and therefore a short-wavelength of light such as is present in an ArF excimer laser or a KrF excimer laser has a very high photo energy. Thus, when an ArF excimer laser or an KrF excimer laser is used for exposing a photoresist film, a blocking group has a greater effect on the solubility characteristics between the exposed and unexposed areas of the photoresist film because the ArF or the KrF excimer laser usually provides a quantity of energy greater than the activation energy for a de-blocking process regardless of the material of the blocking group. Further, when the PEB process is performed on the exposed photoresist film at a temperature of about 130° C., a slight temperature variation of the PEB process (for example, about ±1° C.) causes a variation of the line width of the photoresist pattern. The line width variation is empirically known to be proportional to the temperature variation of the PEB process.

In particular, difficulties are encountered when an ArF excimer laser is used as a light source of an exposure system and the baking process is performed at a temperature above 130° C. to form a photoresist pattern having a line width of no more than about 85 nm at a cell region, because the line width of the photoresist pattern at a peripheral region is very small compared to the target line width of the photoresist pattern at the peripheral region. As a result of the above, the allowable margin for a depth of focus (DOF) of the lens in the exposing system becomes very small. A portion of a wafer such as the cell region in which the photoresist pattern is formed at a relatively high density is referred to as a dense pattern region, and a portion of the wafer such as the peripheral region in which the photoresist pattern is formed at a relatively low density is referred to as an iso-pattern region. The line width of a photoresist pattern is inversely proportional to the solubility of a photoresist composition, and the solubility of a photoresist composition is proportional to the light intensity. Accordingly, the line width of a photoresist pattern is strongly related with the intensity of the light irradiated onto a photoresist film. The ratio of a solubility change with respect to a change in the intensity of the light irradiated onto the photoresist film has a significant effect on the critical dimension of the dense pattern and the iso-pattern. Hereinafter, the ratio of a solubility change with respect to a change of the amount of the light is referred to as iso-dense bias (I/D bias) in view of the pattern size. That is, the lower the I/D bias is, the more the line width of the iso-pattern reaches the target line width.

In an effort to prevent the formation of a small line width for an iso-pattern and to decrease I/D bias, the processing margin of energy latitude (EL) of the exposure process for forming a photoresist pattern has been improved. The meaning of energy latitude (EL) is explained below. For example, when the amount of the light in the exposure system is varied in a predetermined region, the critical dimension of a photoresist pattern may not be varied substantially and the photoresist pattern is uniformly formed in view of the line width despite the variation of the amount of the light irradiated thereto. The light amount variation region described above is known as the energy latitude (EL) of the exposure system. A photoresist composition with a high activation energy and which is relatively insensitive to an amount of energy supplied thereto, is typically used for improving the processing margin of energy latitude (EL). However, a photoresist composition with a high activation energy is undesirable for forming a photoresist pattern with a high resolution and a small critical dimension because the line width of the photoresist pattern formed with this type of photoresist composition will still be small at the peripheral portion of a substrate despite improving the processing margin of the EL.

Therefore, although using a photoresist composition having a high activation energy may produce a line width for the dense pattern which is almost the same as the target line width at the cell region, the line width of the iso-pattern will still deviate from the target line width at the peripheral region of the photoresist pattern. Thus, when a subsequent etching process is performed using the photoresist pattern of which a line width deviates from the target line width as an etching mask, a lifting defect, in which a pattern is lifted from an underlying layer or a substrate, or a bridge defect in which neighboring patterns are interconnected with each other, may be formed when manufacturing a semiconductor device.

Accordingly there is a need for a photoresist composition which results in a photoresist pattern being formed, wherein the line width of the iso-pattern reaches the target line width thereof, so that the difference between the practical line width and the target line width of the iso-pattern is significantly reduced.

### SUMMARY OF THE INVENTION

According to an exemplary embodiment of the present invention, a photoresist composition is provided. The photoresist composition includes a photosensitive resin present in an amount of about 4% by weight to about 10% by weight, a photo-acid generator (PAG), present in an amount of about 0.1% by weight to about 0.5% by weight, and a residual amount of a solvent. The photosensitive resin includes a first resin which includes a first blocking group and a second resin which includes a second blocking group. The second blocking group has an activation energy less than the first blocking group.

According to another exemplary embodiment of the present invention, a method of forming a pattern on an object is provided. The method includes preparing a photoresist composition comprising a photosensitive resin present in an amount of about 4% by weight to about 10% by weight, a photo-acid generator (PAG) present in an amount of about 0.1% by weight to about 0.5% by weight, and a residual amount of a solvent. The photosensitive resin includes a first resin comprising a first blocking group and a second resin comprising a second blocking group having an activation energy less than the first blocking group. Next, the photoresist composition is coated on the object, thereby forming a photoresist film on the object. The photoresist film is then partially exposed to a light passing through a mask that is aligned over the object. A developing process is then performed on the exposed photoresist film, thereby forming a photoresist pattern on the object.

According to the present invention, the photoresist composition including a mixture of blocking groups is less sensitive to a temperature of the PEB process and an intensity change of the light irradiated to the photoresist composition, so that a solubility of the photoresist film in the iso-pattern region is sufficiently reduced. Accordingly, a line width of the iso-pattern reaches the target line width thereof, so the difference between the practical line width and the target line width of the iso-pattern is remarkably reduced

### BRIEF DESCRIPTION OF THE DRAWINGS

FIGS. 1 to 4 are cross sectional views illustrating processing steps of a method of forming a pattern using a photoresist composition according to an exemplary embodiment of the present invention;

FIG. 5 is a scanning electron microscope (SEM) picture showing a photoresist pattern comprising a Comparative Example of photoresist composition;

FIG. 6 is a SEM picture showing an iso-pattern of the photoresist pattern shown in FIG. 5;

FIG. 7 is a SEM picture showing a photoresist pattern comprising an Example of photoresist composition;

FIG. 8 is a SEM picture showing an iso-pattern of the photoresist pattern shown in FIG. 7; and

FIG. 9 is a graph showing a liberation rate of an acid (H+) in a photosensitive resin in relation with a change in intensity of a light irradiated to the photosensitive resin.

### DESCRIPTION OF THE EXEMPLARY EMBODIMENTS OF THE INVENTION

The invention is described more fully hereinafter with reference to the accompanying drawings, in which examples of the invention are shown. This invention may, however, be exemplified in many different forms and should not be construed as limited to the examples set forth herein. In the drawings, the sizes and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross section illustrations that are schematic illustrations of idealized embodiments (and intermediate structures) of the invention. As such, variations from the shapes of the illustrations as a result, for example, of manufacturing techniques and/or tolerances, are to be expected. Thus, examples of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Photoresist Composition

A photoresist composition of the exemplary embodiments of the present invention comprises a photosensitive resin selectively and photo-chemically reacted with light irradiated thereon, a photo-acid generator (PAG) from which an acid is liberated, and a residual amount of a solvent. The photoresist composition is coated on a surface of an object that is to be patterned in a subsequent process.

The photosensitive resin of the photoresist composition includes at least a pair of blocking groups. Moreover, in other exemplary embodiments, the photosensitive resin may further include an adhesion group, a wetting group and an etching-resistive compensation group.

The blocking group is bonded to a monomer of the photosensitive resin, and may be dissociated from the monomer by the acid (H+) liberated from the PAG under the condition that a reaction energy greater than the activation energy is supplied to the photosensitive resin.

Moreover, in the present exemplary embodiment, the photosensitive resin includes a mixture of a first resin including a first blocking group and a second resin including a second blocking group. The activation energy of the first blocking group is significantly higher than the activation energy of the second blocking group.

The activation energy is determined by the molecular weight and the steric hindrance of the blocking group. In particular, the larger the molecular weight is and the greater the steric hindrance is, the greater the activation energy is. The activation energy of the blocking group is defined as the minimal energy required for dissociating the blocking group from the photosensitive resin. Thus, the greater the activation energy is, the less the blocking group is dissociated from the photosensitive resin.

For example, the photosensitive resin comprises the first resin in a range of from about 50% to about 70% by weight, and the second resin in a range of from about 30% to about 50% by weight. In addition, the blocking group in the photosensitive resin comprises the first blocking group in a range of from about 50% to about 70% by weight, and the second blocking group in a range of from about 30% to about 50% by weight.

The first blocking group is difficult to dissociate from the first resin, and therefore the entire first blocking group is typically not dissociated from the first resin after a post-etch baking (PEB) process. For instance, a portion of the first blocking group is dissociated from the first resin after the PEB process, and a residual portion of the blocking group is still bonded to the first resin. Moreover, the entire first blocking group is not photo-chemically reacted with a light irradiated thereon and therefore a complete exposure process is not conducted on the first resin including the first blocking group.

For example, the first blocking group is dissociated from the first resin at a PEB temperature of about 100° C. to about 130° C., and wherein the PEB process is performed with an activation energy of about 14 mJ to about 25 mJ.

In contrast, the second blocking group is dissociated from the second resin at about a temperature less than the PEB temperature, so that the entire second blocking group is dissociated from the second resin at an end stage of the PEB process. For example, the dissociation of the second blocking group from the second resin initiates at the temperature lower than the PEB temperature of about 100° C. to about 130° C., and the dissociation process is maintained until the end stage of the PEB process. Accordingly, the second blocking group is completely dissociated from the second resin when the PEB process is completed.

Additionally, because of the first and second blocking groups of the exemplary embodiments of the present invention the ratio of the solubility change with respect to the change in the amount of light irradiated onto the photoresist composition becomes much smaller than that obtained with a conventional photoresist composition. As a result, the photoresist compositions of the present exemplary embodiments provide a difference between the practical line width and the target line width of the iso-pattern which is significantly reduced in comparison to conventional photoresist compositions.

However, when the photosensitive resin comprises the first resin in an amount more than about 70% by weight or comprises the second resin in an amount less than about 30% by weight, the first and second blocking groups are dissociated much less from the photosensitive resin, thereby causing the photoresist film comprising the photosensitive resin to be patterned deficiently and also causing the neighboring photoresist patterns connected with each other to generate a bridge defect.

In contrast, when the photosensitive resin comprises the first resin in an amount less than about 50% by weight or comprises the second resin in an amount more than about 50% by weight, the first and second blocking groups are excessively dissociated from the photosensitive resin, so that the solubility of the photosensitive resin is excessively high and a photoresist pattern is lifted from an underlying layer or a wafer.

Therefore in the present exemplary embodiments, the photosensitive resin comprises the first blocking group in a range of from about 50% to about 70% by weight, and the second blocking group in a range of from about 30% to about 50% by weight. In other exemplary embodiments, the photosensitive resin comprises the first blocking group in a range of from about 55% to about 65% by weight, and the second blocking group in a range of from about 35% to about 45% by weight.

Each of the first and second resins of the present exemplary embodiment, which do not react with the solvent, should have a sufficient solubility and drying rate to form a uniform photoresist film after evaporation of the solvent. Any materials satisfying the above conditions may be used as the first and second resins in accordance with the exemplary embodiments of the present invention.

Examples of the first resin include but are not limited to an acrylate, a cyclo-clefin methacrylate, and a cyclo-olefin resin, and a combination thereof. For example, the acrylate may include but is not limited to any one of methacrylate, vinyl ether methacrylate (VEMA), cyclo-olefin methacrylate (COMA) and a combination thereof.

Examples of the second resin also include but are not limited to an acrylate, a cyclo-clefin methacrylate, and a cyclo-olefin resin and a combination thereof. For example, the acrylate may include but is not limited to any one of methacrylate, vinyl ether methacrylate (VEMA), cyclo-olefin methacrylate (COMA) and a combination thereof. The first resin may be identical to the second resin or may be different from the second resin.

The above dissociation of the blocking group from the photosensitive resin requires predetermined amounts of heat, and acid (H+) that is liberated from the PAG. The PAG is characterized in that the acid (H+) is liberated therefrom by irradiation of the light.

When the photosensitive resin comprises less than about 0.1% by weight of the PAG, the acid (H+) is not sufficiently liberated from the PAG and the blocking group is deficiently dissociated from the photosensitive resin. Consequently, the photoresist film does not sufficiently dissolve away in a subsequent developing process. In contrast, when the photosensitive resin comprises more than about 0.5% by weight of the PAG, the acid (H+) is excessively liberated from the PAG to thereby dissociate the blocking group from the photosensitive resin. Accordingly, the photoresist film is excessively dissolved away in a subsequent developing process, and a top portion of a photoresist pattern is excessively removed (which is often referred to as top loss).

Further, the photosensitive resin of this exemplary embodiment comprises the PAG in a range of from about 0.1% to about 0.5% by weight and more preferably, in a range of from about 0.15% to about 0.4% by weight.

The PAG includes but is not limited to any one selected from the group consisting of monophenyl sulfonium, diphenyl sulfonium, triphenyl sulfonium and a combination thereof. An example of the triphenyl sulfonium includes but is not limited to triphenylsulfonium triflate, triphenylsulfonium nonaflate, triphenylsulfonium perfluorooctanesulfonates and combinations thereof.

Monophenyl sulfonium has a higher light transmittance and a lower liberation rate of acid (H+) than those of diphenyl sulfonium. Moreover, diphenyl sulfonium has a higher light transmittance and a lower liberation rate of acid (H+) than those of triphenyl sulfonium.

Dissociation energy for dissociating the blocking group from the photosensitive resin is supplied during the PEB process after an exposure process to the photoresist film. When the PEB process is performed at a temperature less than about 100° C., the dissociation energy is less than the activation energy and the blocking group is hardly dissociated from the photosensitive resin. In contrast, when the PEB process is performed at a temperature more than about 130° C., too much heat energy is supplied as the dissociation energy and a photoresist pattern has a non-uniform line width.

In addition to the photosensitive resin and the photoacid generator (PAG), the photoresist composition also comprises a residual portion or amount of a solvent. An example of the solvent includes but is not limited to propylene glycol monomethyl ether acetate (PGMEA), methyl 2-hydroxyisobutyrate (HBM), ethyl lactate, cyclohexanone, heptanone, lactone and combinations thereof.

As mentioned above, the photoresist composition of the present exemplary embodiment of the invention, including a mixture of the first and second resins as the blocking groups which are less sensitive to the temperature of a PEB process and a change in the intensity of the light irradiated onto the photoresist composition. Thus, the solubility of the photoresist film in the iso-pattern region is sufficiently reduced. Additionally, as a result, the line width of the iso-pattern reaches the target line width thereof, so that the difference between the practical line width and the target line width of the iso-pattern is significantly reduced in comparision to conventional photoresist compositions. For example, with the photoresist compositions of the present exemplary embodiment, the difference between the practical line width and the target line width is preferably no less than about 30 nm.

Method of Forming a Pattern Using the Photoresist Composition

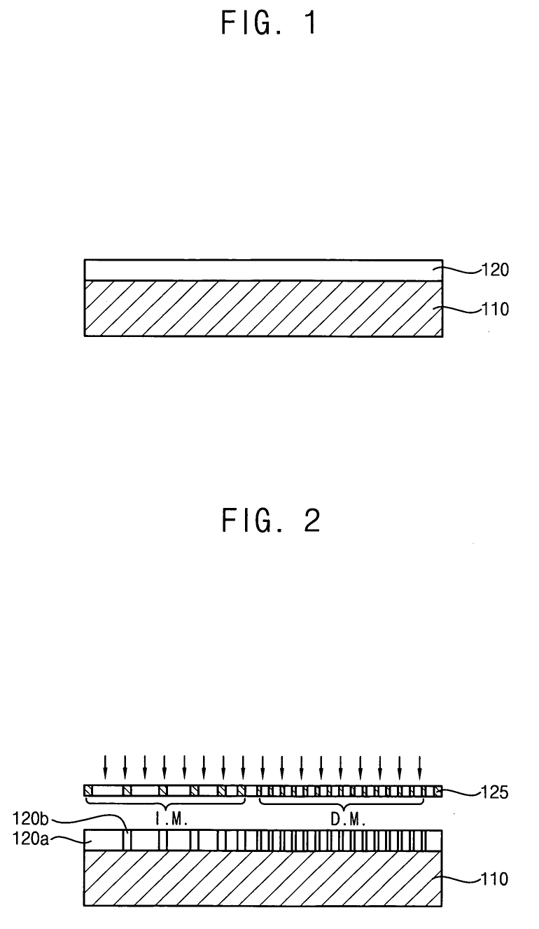

FIGS. 1 to 4 are cross sectional views illustrating processing steps of a method of forming a pattern using a photoresist composition according to an exemplary embodiment of the present invention.

Referring to FIG. 1, a photoresist composition is prepared for forming a photoresist pattern on a wafer 110. The photoresist composition comprises a photosensitive resin present in an amount of about 4% by weight to about 10% by weight, a photo-acid generator (PAG) present in an amount of about 0.1% by weight to about 0.5% by weight, and a residual amount of a solvent. The photosensitive resin includes a first resin including a first blocking group and a second resin including a second blocking group having an activation energy less than the first blocking group.

In the present embodiment, the photosensitive resin comprises the first blocking group in a range of from about 50% to about 70% by weight, and the second blocking group in a range of from about 30% to about 50% by weight. In particular, the photosensitive resin comprises the first blocking group in a range of from about 55% to about 65% by weight, and the second blocking group in a range of from about 35% to about 45% by weight.

The first blocking group is difficult to be dissociated from the first resin, so that the entire first blocking group is not dissociated from the first resin after a post-etch baking (PEB) process. That is, a portion of the first blocking group is dissociated from the first resin after the PEB process, and a residual portion of the first blocking group is still bonded to the first resin. In contrast, the second blocking group is dissociated from the second resin at a temperature less than about a PEB temperature at which the PEB process is performed, so that every second blocking group is dissociated from the second resin at an end stage of the PEB process. That is, the dissociation of the second blocking group from the second resin initiates at the second PEB temperature lower than the first PEB temperature of about 100° C. to about 130° C. and the dissociation process is maintained until the end stage of the PEB process. Accordingly, the second blocking group is completely dissociated from the second resin when the PEB process is completed.

Accordingly, when the photoresist composition comprises the first and second blocking groups, a ratio of a solubility change with respect to a change of the amount of a light irradiated to the photoresist composition becomes much smaller than that of a conventional photoresist composition, so that a difference between a practical line width and a target line width of the iso-pattern is remarkably reduced.

The photoresist composition of the exemplary embodiments of the invention has already been described above, so any detailed description on the elements of the photosensitive composition, including the photosensitive resin, the first and second blocking groups, the PAG and the solvent will be omitted to avoid redundancy.

The photoresist composition is coated on the wafer and a soft-baking process is performed on the wafer 110, thereby forming a photoresist film 120 on the wafer 110 to a predetermined thickness. In this exemplary embodiment, the soft-baking process is performed at a temperature of about 90° C. to about 110° C.

The wafer 110 further includes an anti-reflection layer, and an insulation layer or a conductive layer on the anti-reflection layer. The insulation layer includes a silicon oxide layer such as borophosphosilicate glass (BPSG) layer, and the conductive layer includes a polysilicon layer doped with impurities. In the present exemplary embodiment, the insulation layer is formed on the wafer, and the photoresist film is formed on the insulation layer.

Referring to FIG. 2, a mask is aligned over the wafer 110 on which the photoresist film 120 is formed. Then, light is irradiated onto the photoresist film 120 at a first intensity through the mask, and a photosensitive resin in the photoresist film 120 is photo-chemically and selectively reacted with the light to thereby define an exposed portion 120a and an unexposed portion 120b on the photoresist film in accordance with the mask pattern on the mask. In the exposed portion 120a, some blocking groups are dissociated from the photosensitive resin of the photoresist film 120.

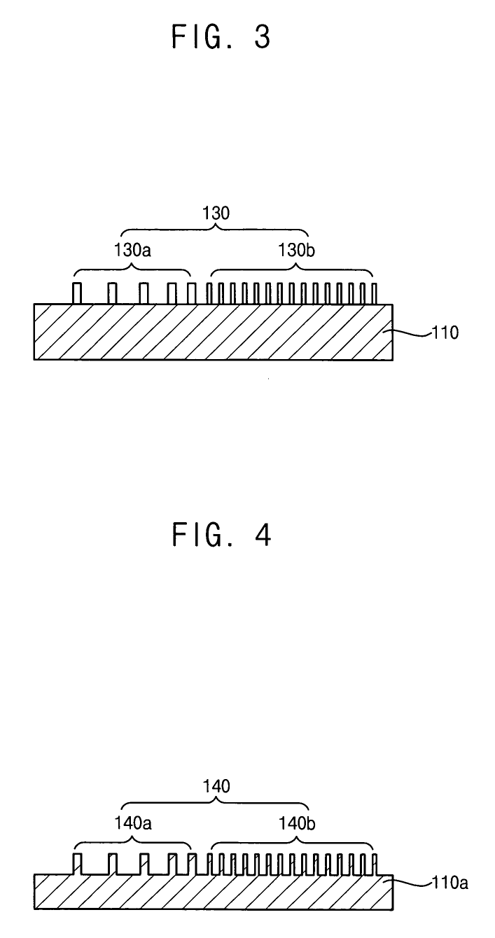

The mask pattern on the mask includes a dense mask pattern DM of which a density is relatively high and of which a line width is relatively small, and an iso-mask pattern IM of which a density is relatively low and of which a line width is relatively large. Hereinafter, a photoresist pattern that is to be formed in accordance with the dense mask pattern DM is referred to as a dense pattern 130b in FIG. 3, and a photoresist pattern that is to be formed in accordance with the iso-mask pattern IM is referred to as an iso-pattern 130a in FIG. 3. In the present exemplary embodiment, the line width of the dense mask pattern DM is the target line width of the dense pattern 130b of the photoresist pattern 130 and the line width of the iso-mask pattern IM is the target line width of the iso-pattern 130a of the photoresist pattern 130. The intensity of the light irradiated onto the mask is determined in accordance with the target line width of the dense pattern 130b on the wafer 110, so that the first intensity of the light is of a sufficient intensity such that the dense pattern 130b is formed with a width almost identical to the line width of the dense mask pattern DM. That is, the exposure process is performed in such a way that the dense pattern 130b has substantially the same line width as the dense mask pattern DM.

The photoresist composition of the exemplary embodiments of the present invention is photo-chemically reacted with a light of which the wavelength is less than about 240 nm, and particularly, to a light of which the wavelength is less than about 193 nm such as an argon fluoride (ArF) excimer laser. Although the above example exemplary embodiment discusses the ArF excimer laser, any other light source known to one of the ordinary skill in the art as having a proper wavelength may also be utilized in place of or in conjunction with the ArF excimer laser.

Referring to FIG. 3, a post-etch bake (PEB) process, a developing process, a cleaning process and a dry process are sequentially performed on the wafer including the partially exposed photoresist film, thereby forming a photoresist pattern 130 including the iso-pattern 130a and the dense pattern 130b.

The acid (H+) is liberated from the PAG by the light, and the blocking group is dissociated from the photosensitive resin by heat in the PEB process, so that a solubility difference is created between the exposed portion 120a and the unexposed portion 120b of the photoresist film 120. The solubility difference is determined in accordance with the heat energy supplied during the PEB process. However, the photoresist composition of the present exemplary embodiment includes the mixture of the first blocking group, of which the activation energy is relatively high, and the second blocking group, of which the activation energy is relatively low, so that the solubility difference between the exposed portion 120a and the unexposed portion 120b is smaller than that of a conventional photoresist film, thereby improving the contrast of the photoresist film 120.

Then, the wafer 110 including the partially exposed photoresist film is immersed into a developing solution, such as an alkali solution, and the exposed portion 120a is dissolved away into the developing solution. Accordingly, the unexposed portion 120b of the photoresist film 120 remains on the insulation layer that is formed on the wafer 110, to thereby form a photoresist pattern 130 through which the insulation layer is partially exposed on the wafer 110.

The photoresist pattern 130 includes the iso-pattern 130a of which the density is relatively low and the dense pattern 130b of which the density is relatively high. Although the light in the exposure system is irradiated onto the photoresist film at such a light intensity that the dense pattern 130b is formed with a line width substantially identical to a line width of the dense mask pattern DM, the iso-pattern is also formed with a line width much more adjacent to the line width of the iso-mask pattern IM. That is, the difference between the line width of the iso-pattern 130a and the line width of the iso-mask pattern IM is significantly decreased even though the light intensity is still controlled based on the line width of the dense pattern 130b. For example in this exemplary embodiment, the difference between the practical line width and the target line width is no less than about 30 nm.

Referring to FIG. 4, the exposed insulation layer is removed away from the wafer 110 by, for example, a dry etching process, thereby forming an insulation pattern 140 on a bare wafer 110a. The insulation pattern 140 is formed in accordance with the shape of the photoresist pattern 130, and includes an iso-insulation pattern 140a that is formed in accordance with the iso-pattern 130a. The dense insulation pattern 140b is formed in accordance with the dense pattern 130b. Consequently, the difference between the line width of the iso-insulation pattern 140a and the line width of the iso-mask pattern IM is significantly decreased even though the light intensity is still controlled based on the line width of the dense pattern 130b. Thereafter, the photoresist pattern 130 is removed from the insulation pattern 140 and only the insulation pattern 140 remains on the wafer 110.

Hereinafter, the exemplary embodiments of the present invention are described in more detail by a comparison of an Example representing a photoresist composition according to an exemplary embodiment of the present invention and a Comparative Example of representing a conventional photoresist composition. Various experiments were conducted so as to verify characteristics of the photoresist composition of the present invention using Example and Comparative Example of the photoresist composition as follows.

### EXAMPLE

About 42 parts by weight of methyl acrylate including methyl adamantane, about 28 parts by weight of methacrylate including ethyl cyclohexane, about 25 parts by weight of monophenyl sulfonate, about 10 parts by weight of a quencher and about 895 parts by weight of a solvent were mixed with each other. The impurities were filtered off from the mixture by a 0.2 μm membrane filter, to thereby prepare a photoresist composition in accordance with an exemplary embodiment of the present invention that is then photo-chemically reacted with an ArF excimer laser. In this Example of the photoresist composition, the methyl acrylate was used as the first blocking group and the methacrylate was used as the second blocking group. Further, the monophenyl sulfonate was used as the PAG.

### COMPARATIVE EXAMPLE

About 70 parts by weight of methyl acrylate, about 25 parts by weight of monophenyl sulfonate, about 10 parts by weight of a quencher and about 895 parts by weight of a solvent were mixed with each other. The impurities were filtered off from the mixture by a 0.2 μm membrane filter, to thereby prepare this Comparative Example of a photoresist composition that is then photo-chemically reacted with an ArF excimer laser. Further, in this Comparative Example of the photoresist composition, the methyl acrylate was used as the blocking group and the monophenyl sulfonate was used as the PAG.

Experiment 1 on a Photoresist Pattern

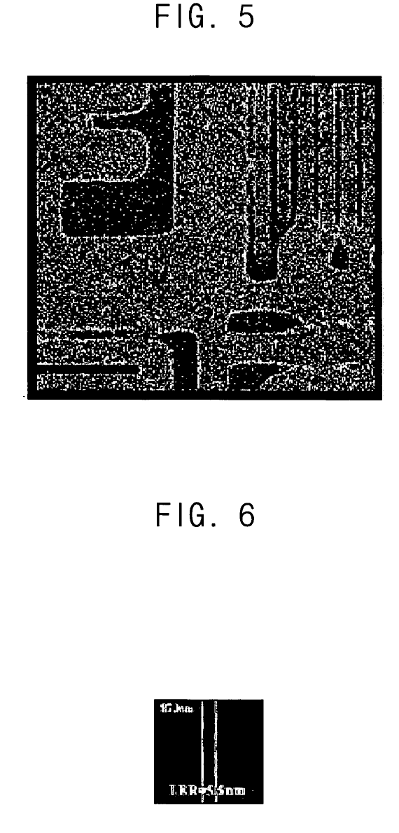

An anti-reflection layer and a BPSG layer were formed on a wafer, and the photoresist composition in the Comparative Example was coated on the BPSG layer. Then, a baking process was performed on the wafer, thereby forming a first photoresist film on the wafer. A mask on which a mask pattern was formed was aligned over the wafer, and an ArF excimer laser was irradiated onto the first photoresist film through the mask. The mask pattern included a dense mask pattern of which a line width was about 90 nm and an iso-mask pattern of which a line width was about 160 nm. The ArF laser was irradiated at such an intensity that a photoresist pattern was formed with a line width substantially identical to about 90 nm. The first photoresist film was selectively exposed by the ArF laser in accordance with the mask pattern on the mask. The PEB process was performed on the wafer at a temperature of about 120° C., and then a developing process and a cleaning process were sequentially performed on the wafer, thereby forming the first photoresist pattern including a dense pattern of which a density was relatively high and an iso-pattern of which a density was relatively low. An electron microscope took pictures of the first photoresist pattern as shown in FIGS. 5 and 6. FIG. 5 is a scanning electron microscope (SEM) picture showing the first photoresist pattern, and FIG. 6 is a scanning electron microscope (SEM) picture showing the iso-pattern of the first photoresist pattern shown in FIG. 5.

Referring to FIGS. 5 and 6, the dense pattern of the first photoresist pattern had a line width of about 87 nm and a little top loss was verified at the top portion of the dense pattern of the first photoresist pattern. In contrast, the iso-pattern of the first photoresist pattern had a line width of about 87 nm, which was considerably deviated from the target line width of about 160 nm corresponding to a line width of the iso-mask pattern. In addition, a further top loss was verified at the top portion of the iso-pattern of the first photoresist pattern. FIGS. 5 and 6 indicate that the photoresist composition in this Comparative Example was so sensitive to the ArF excimer laser that the blocking group was excessively dissociated from the photosensitive resin thereof at a peripheral region of the wafer. That is, the photoresist composition in this Comparative Example was excessively dissolved into the developing solution at the peripheral region of the wafer at the same rate as when the photoresist composition in this Comparative Example was dissolved into the developing solution at the cell region of the wafer.

Experiment 2 on a Photoresist Pattern

A second photoresist pattern was formed in the same way as the first photoresist pattern except that the photoresist composition in the Example was coated on the BPSG layer in place of the photoresist composition in the Comparative Example.

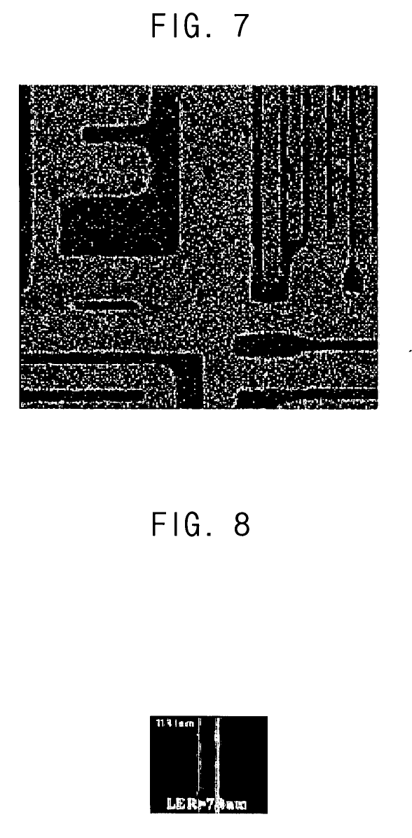

An anti-reflection layer and a BPSG layer were also formed on a wafer. Moreover, the photoresist composition in the Example was coated on the BPSG layer, and a baking process was performed on the wafer, thereby forming a second photoresist film on the wafer. A mask on which a mask pattern was formed was aligned over the wafer, and an ArF excimer laser was irradiated onto the second photoresist film through the mask. The mask pattern included a dense mask pattern of which the line width was about 90 nm and an iso-mask pattern of which the line width was about 160 nm. The ArF laser was irradiated at such an intensity that a photoresist pattern was to be formed with a line width substantially identical to about 90 nm. The second photoresist film was selectively exposed by the ArF laser in accordance with the mask pattern on the mask. The PEB process was performed on the wafer at a temperature of about 120° C., and then a developing process and a cleaning process were sequentially performed on the wafer, thereby forming a second photoresist pattern including a dense pattern, of which a density was relatively high and an iso-pattern of which a density was relatively low. An electron microscope took pictures of the second photoresist pattern as shown in FIGS. 7 and 8. FIG. 7 is a scanning electron microscope (SEM) picture showing the second photoresist pattern, and FIG. 8 is a SEM picture showing the iso-pattern of the second photoresist pattern shown in FIG. 7.

Referring to FIGS. 7 and 8, the dense pattern of the second photoresist pattern had a line width of about 88 nm and no top loss was verified at the top portion of the dense pattern of the second photoresist pattern. Further, the iso-pattern of the second photoresist pattern had a line width of about 113 nm, and which was much less deviated from the target line width of about 160 nm corresponding to a line width of the iso-mask pattern. In addition, no top loss was verified at the top portion of the iso-pattern of the second photoresist pattern. A line width of the iso-pattern of the second photoresist pattern was larger than that of the first photoresist pattern by as much as about 26 nm. FIGS. 7 and 8 indicate that the photoresist composition in the Example was less sensitive to the ArF excimer laser than that of the photoresist composition in the Comparative Example. Thus, the blocking group was deficiently dissociated from the photosensitive resin of the photoresist composition in the Example at a peripheral region of the wafer. That is, the photoresist composition in the Example was dissolved into the developing solution at the peripheral region of the wafer at a smaller rate than at the cell region of the wafer.

Experiment on a Solubility of a Photoresist Composition

An experiment on the solubility of a photoresist composition was performed using the photoresist composition in the Comparative Example and the photoresist composition in the Example. A line width of a photoresist pattern is strongly related with a solubility of an exposed portion of a photoresist film, and the solubility of the exposed portion is strongly related with an amount of the liberated acid (H+) in the exposed portion. Further, the amount of the acid (H+) is proportional to a light intensity. For the above reasons, an experiment on the solubility of a photoresist composition was conducted by detecting a liberation rate of the acid (H+) from a photosensitive resin in relation with a change in intensity of the light irradiated onto the photoresist composition.

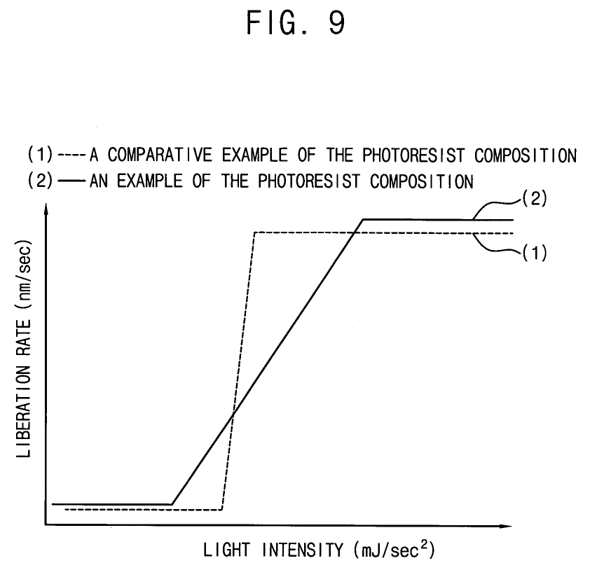

FIG. 9 is a graph showing a liberation rate of the acid (H+) in a photosensitive resin in relation with the change in intensity of the light irradiated onto the photosensitive resin. In FIG. 9, Graph 1 shows the liberation rate of the acid (H+) from the photoreist composition in Comparative Example, and Graph 2 shows the liberation rate of the acid (H+) from the photoresist composition in Example.

Referring to FIG. 9, the slope of Graph 1 was significantly larger than that of Graph 2, so that the acid (H+) was more abundantly liberated from the photoresist composition in the Comparative Example than from the photoresist composition in the Example at the same intensity change of the light. In view of a pattern size, the slope of Graph 1 and Graph 2 is often known as I/D bias. The mixture of the blocking groups effectively reduced the liberation rate of the acid (H+) at the same intensity change of the light, so that the acid (H+) was much less liberated from the photoresist composition in the Example even though the light was supplied to the second photoresist film under the same conditions.

When the acid (H+) was excessively liberated from the photosensitive resin in the exposed portion of the first photoresist film, the acid (H+) was diffused into the unexposed portion thereof during the PEB process, so that a solubility of the second photoresist film was very large regardless of a cell region and a peripheral region of a wafer. The first photoresist film was dissociated into a developing solution substantially at the same rate both at the cell region and the peripheral region of the wafer. Accordingly, the line width of the iso-pattern was far off from the target line width.

In contrast, when the acid (H+) was deficiently liberated from the photosensitive resin in the exposed portion of the second photoresist film, the acid (H+) was hardly diffused into the unexposed portion thereof during the PEB process, so that the solubility of the exposed portion of the second photoresist film still remained unchanged and the solubility of the unexposed portion of the second photoresist film was significantly reduced. The second photoresist film was less dissociated into a developing solution at the peripheral region than at the cell region of the wafer.

Accordingly, the line width of the iso-pattern sufficiently approached the target line width.

According to the exemplary embodiments of the present invention, the photoresist composition including a mixture of blocking groups is less sensitive to the temperature of the PEB process and the change in the intensity of the light irradiated onto the photoresist composition, so that a solubility of the photoresist film in the iso-pattern region is sufficiently reduced. Accordingly, the line width of the iso-pattern reaches the target line width thereof, so the difference between the practical line width and the target line width of the iso-pattern is significantly reduced. When a patterning process is performed using the photoresist pattern comprising the photoresist composition of the exemplary embodiments of the invention for manufacturing a semiconductor device, the reliability of the device is improved and the processing time and costs are also reduced. In particular, the photoresist composition is especially beneficial when applied to a manufacturing process for a next-generation semiconductor device, of which the degree of integration is high.

Having described the exemplary embodiments of the present invention, it is further noted that it is readily apparent to those of reasonable skill in the art that various modifications can be made without departing from the spirit and scope of the present invention which is defined by the metes and bounds of the appended claims.

What is claimed is:

1. A photoresist composition comprising a photosensitive resin present in an amount of about 4% by weight to about 10% by weight, a photo-acid generator (PAG) present in an amount of about 0.1% by weight to about 0.5% by weight; and a residual amount of a solvent, the photosensitive resin comprises a first resin comprising a first blocking group and a second resin comprises a second blocking group having an activation energy less than the first blocking group.

2. The photoresist composition of claim 1, wherein the photosensitive resin comprises the first resin in a range of from about 50% to about 70% by weight, and the second resin in a range of from about 30% to about 50% by weight.

3. The photoresist composition of claim 1, wherein the first blocking group is dissociated from the first resin by a heat energy of about 14 mJ to about 25 mJ.

4. The photoresist composition of claim 1, wherein the first resin is selected from the group consisting of methacrylate, vinyl ether methacrylate (VEMA), cyclo-olefin methacrylate (COMA) and a combination thereof.

5. The photoresist composition of claim 1, wherein the second resin is selected from the group consisting of methacrylate, vinyl ether methacrylate (VEMA), cyclo-olefin methacrylate (COMA) and a combination thereof.

6. The photoresist composition of claim 1, wherein the PAG is selected from the group consisting of monophenyl sulfonium, diphenyl sulfonium, triphenyl sulfonium and a combination thereof.

7. The photoresist composition of claim 1, wherein the solvent is selected from the group consisting of propylene glycol monomethyl ether acetate (PGMEA), methyl 2-hydroxyisobutyrate (HBM), ethyl lactate, cyclohexanone, heptanone, lactone and a combination thereof.

8. A method of forming a pattern on an object, comprising:
preparing a photoresist composition including a photosensitive resin present in an amount of about 4% by weight to about 10% by weight, a photo-acid generator (PAG) present in an amount of about 0.1% by weight to about 0.5% by weight; and a residual amount of a solvent, the photosensitive resin comprises a first resin comprising a first blocking group and a second resin comprises a second blocking group having an activation energy less than the first blocking group;
coating the photoresist composition on the object, thereby forming a photoresist film on the object;
partially exposing the photoresist film to a light passing through a mask that is aligned over the object; and
developing the exposed photoresist film, thereby forming a photoresist pattern on the object.

9. The method of claim 8, wherein the photosensitive resin comprises the first resin in a range of from about 50% to about 70% by weight, and the second resin in a range of from about 30% to about 50% by weight.

10. The method of claim 8, wherein the first blocking group is dissociated from the first resin by a heat energy of about 14 mJ to about 25 mJ.

11. The method of claim 8, after exposing the photoresist film, further comprising performing a post-etch baking (PEB) process on the object at a temperature of about 100° C. to about 130° C.

12. The method of claim 11, when a portion of the first blocking group is dissociated from the first resin in the PEB process, and a residual portion of the first blocking group is still bonded to the first resin.

13. The method of claim 11, wherein the second blocking group is dissociated from the second resin in the PEB process.

14. The method of claim 11, wherein the dissociation of the second blocking group initiates at a temperature no more than a PEB temperature, at which the PEB process is performed.

15. The method of claim 8, wherein the first resin is selected from the group consisting of methacrylate, vinyl ether methacrylate (VEMA), cyclo-olefin methacrylate (COMA) and a combination thereof.

16. The method of claim 8, wherein the second resin is selected from the group consisting of methacrylate, vinyl ether methacrylate (VEMA), cyclo-olefin methacrylate (COMA) and a combination thereof.

17. The method of claim 8, wherein the light has a wavelength of no more than about 193 nm.

18. The method of claim 8, further comprising partially etching the object using the photoresist pattern as an etching mask, thereby forming the pattern.

19. The method of claim 8, wherein the pattern includes a dense pattern having a relatively high density and a relatively small line width and an iso-pattern having a relatively low density and a relatively large line width.

20. The method of claim 19, wherein a difference between the line width and a target line width of the iso-pattern is no less than about 30 nm.

21. The photoresist composition of claim 2, wherein the photosensitive resin comprises the first resin in a range of from about 55% to about 65% by weight, and the second resin in a range of from about 35% to about 45% by weight.

22. The method of claim 8, wherein the photosensitive resin comprises the first resin in a range of from about 55% to about 65% by weight, and the second resin in a range of from about 35% to about 45% by weight.

23. The method of claim 17, wherein the light is an argon fluoride (ArF) excimer laser.
